(19) United States
(12) Patent Application Publication
(10) Pub. No.: US 2005/0058069 A1
(43) Pub. Date: Mar. 17, 2005

(54) Processing of data packets adaptable as a function of an internal load status, for routing in a QoS architecture

(75) Inventors: Philippe Dauchy, Paris (FR); Alberto Conte, Paris (FR); Yuke Wang, Plano, TX (US); Anand Krishnamurthy, Fremont, CA (US)

Correspondence Address: SUGHRUE MION, PLLC, 2100 Pennsylvania Avenue, NW, Washington, DC, 20037-3213, US

(73) Assignee: ALCATEL

(21) Appl. No.: 10/900,082

(22) Filed: Jul. 28, 2004

(30) Foreign Application Priority Data
Jul. 29, 2003 (FR) 03 09 286

(51) Int. Cl. H04L 1/00

(52) U.S. Cl. 370/230; 370/235; 370/351

(57) ABSTRACT

A router of a communication network, for example an Internet Protocol communication network, comprises processors for determining its internal load status and, on receiving a flow of packets of data associated with a traffic class, assigning certain internal resources of the router to the received flow as a function of the traffic class of the flow and the determined load status of the router.

### CROSS-REFERENCE TO RELATED APPLICATIONS

This application is based on French Patent Application No. 03 09 286 filed Jul. 29, 2003, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to the field of communication networks capable of processing flows of packets of data and aggregates of flows, to be more precise to those having an architecture capable of managing quality of service, known as a “QoS architecture”.

2. Description of the Prior Art

In the present context, the expression “quality of service” refers to a level of service defined by values of traffic characteristics or parameters such as instability (also known as “jitter”), packet loss rate, and packet transmission delay.

In the conventional networks referred to above, for example Internet Protocol (IP) networks, traffic is processed as quickly as possible in core routers or edge routers. This type of processing corresponds to a minimum service known as a “best effort service”. Consequently, in this type of network, the quality of service (QoS) cannot be guaranteed for each flow of packets of data, or at least for each class of traffic.

In the present context, the expression “flow of packets of data” refers to a flow in which all the packets have in their header the same flow identifier, generally consisting of five “tuples” (source IP address, destination IP address, transmission (or transport) protocol identifier, port dedicated to source transmission protocol, and port dedicated to destination transmission protocol).

In the present context, the expression “class of traffic” refers either to traffic of the “flow by flow” type, in which flows are processed independently of each other as a function of their flow identifier, or “aggregate of flows” traffic, in which flows are grouped into aggregates generally defining classes designated by a class identifier integrated into the header of the packets.

Several QoS architectures have been proposed to enable partial taking into account of the quality of service in Internet Protocol networks, including integrated services (IntServ) architectures, differentiated services (DiffServ) architectures, and dynamic packet state (DPS) architectures.

In an IntServ architecture, internal resources are reserved for each flow of packets in each router of the network.

In the present context, the expression “internal resources” refers to resources specific to a router, for example buffer memory areas, link capacities or available computation (CPU) time.

In an IntServ architecture, each router on the path of a flow must store status information representative of the quality of service associated with the flow. Each flow is identified by a flow identifier placed in the header of the packets (where it occupies 112 bits in the case of the IPv4 protocol and 304 bits in the case of the IPv6 protocol). Thus all the packets of the same flow are able to receive the same service defined by the status information associated with said flow stored in the routers of the path of that flow. In this type of architecture, a quality of service can therefore be guaranteed for each flow.

However, in this type of architecture, the amount of status information to be stored in a router increases with the number of flows in transit through the router. This storage involves a great deal of processing and monopolizes a great deal of memory resources in each router, and in the core routers in particular. Consequently, the IntServ architecture is not well adapted to an increase in the traffic load.

In a DiffServ architecture, two to eight classes are generally defined, each class being designated by a class identifier placed in the header of the packets (where it occupies six bits in the case of the IPv4 and IPv6 protocols). The class identifier is generally integrated into the header of a packet by the input router which receives the packet first in a DiffServ domain. Internal resources are reserved for each class in each router of the network. Consequently, packets belonging to different classes may receive different services.

In this type of architecture, the amount of status information that each router must store is therefore equal to the number of classes. This type of architecture is therefore apparently adapted to an increase in the traffic load. When all the resources of the router are assigned to different classes, and the packets of those classes are grouped in flow aggregates, the quality of service offered to the flows of an aggregate may be affected by the behavior of other flows in the same class. Consequently, a quality of service may not be guaranteed for each flow within the same class.

In a DPS architecture, the packets carry the status information for their flow, to avoid the routers having to install and maintain the status information for each flow in transit. To be more precise, the input router of a DPS domain integrates the status information into the header of the packet, where it generally occupies 17 bits. The core routers process the packets as a function of their status information and their own status information. A core router may update its own status information and the status information of a packet before forwarding it to the next router.

This type of DPS architecture thus enables processing of each flow, and is apparently suited to an increase in the traffic load. However, it necessitates the installation in each core router of a specific programming scheme enabling it to effect programming based on the status information contained in the packet headers.

There being no prior art architecture providing an entirely satisfactory solution, an object of the invention is to improve on this situation.

### SUMMARY OF THE INVENTION

To this end the invention proposes a router for a communication network, for example an Internet Protocol (IP) network, comprising processing means adapted, on receiving a flow of packets of data associated with a class of traffic, to assign the flow internal resources of the router as a function of its traffic class in order for it to be transmitted to another router of the network.

The method of the invention may have additional features, implemented separately or in combination, and in particular:
the traffic class being selected from the group comprising “flow by flow” traffic and “flow aggregate” traffic.
processing means adapted, when the load is high, to aggregate received flows associated with the same traffic class, in order to define local aggregates and to assign the local aggregates internal resources assigned to that traffic class, at least temporarily. When the load is really very high, the processing means may even be adapted to aggregate locally flow aggregates associated with the some traffic class, in order to define local aggregate aggregates and to assign to the local aggregate aggregates internal resources assigned to that traffic class, at least temporarily,
processing means adapted, in the event of the load being reduced (releasing of internal resources assigned to a traffic class), to de-aggregate flows or flow aggregates of that traffic class previously aggregated locally, and then to assign the flows or flow aggregates at least certain of the released internal resources,
processing means adapted, when the packets of a flow comprise quality of service (QoS) information and the load status allows it, to de-aggregate flows previously aggregated locally and assign them released local resources corresponding to the quality of service information contained in their respective packets,
memories adapted to store received packets and packets awaiting transmission temporarily in queues as a function of an order of arrival and of the traffic class to which they belong. In this case the processing means are advantageously adapted to define within each queue associated with a traffic class a primary storage region dedicated to flow aggregation and at least one secondary storage region dedicated to a flow of this traffic class.
   The processing means may then be adapted to assign a selected set of internal resources to a primary region associated with a traffic class and then, on receipt of each new flow belonging to the traffic class, to define a new secondary region and assign that secondary region a selected portion of the resources initially assigned to the primary region, provided of course that the number of secondary regions is below a selected threshold. When all the secondary regions have been defined, each new flow belonging to the traffic class is stored in the associated primary region for processing in flow aggregate form.
   Also if the processing means detect an end of flow associated with a secondary region associated with a traffic class, they reassign to the primary region associated with the traffic class all of the resources previously assigned to the secondary region.
   The processing means are advantageously adapted to determine a load status for each traffic class associated with a primary region by counting the number of secondary regions defined associated with the primary region.

The invention further provides a method of processing packets of data for routing in a communication network, for example an Internet Protocol network, comprising routers adapted, on receiving a flow of packets of data associated with a class of traffic, to assign the flow internal resources as a function of its traffic class in order for it to be transmitted to at least one other router of the network.

This method is characterized in that it consists in, when a flow of packets is received at a router, determining an internal load status of the router and then assigning internal resources to the received flow as a function of its traffic class and of the load status that has been determined.

The method of the invention may have additional features, implemented separately or in combination, and in particular:
the traffic class may be selected from the group comprising “flow by flow” traffic and “flow aggregate” traffic.
when the load status is representative of a high load, received flows associated with the same traffic class may be aggregated to define local aggregates, and then the local aggregates are assigned internal resources of the router concerned, assigned to the traffic class, at least temporarily,
when the load status is representative of a very high load, flow aggregates associated with the same traffic class may be aggregated locally to define local aggregate aggregates, and then the local aggregate aggregates are assigned internal resources of the router concerned, allocated to the traffic class, at least temporarily,
in the event of releasing of internal resources assigned to a traffic class at a router, flows or flow aggregates previously aggregated locally may be de-aggregated and then the flows or flow aggregates are assigned at least certain of the released internal resources,
when the packets of a flow contain quality of service (QoS) information and the load status of a router allows it, flows previously aggregated locally are de-aggregated and assigned local resources corresponding to the quality of service information contained in their respective packets,
in the presence of routers comprising memories adapted to store received packets and packets awaiting transmission temporarily in queues as a function of an order of arrival and of belonging to a traffic class, there may be defined within each queue associated with a traffic class a primary storage region dedicated to flow aggregation and at least one secondary storage region dedicated to a flow of this traffic class.
A selected set of internal resources may then be assigned to a primary region associated with a traffic class and then, on receipt of each new flow belonging to the traffic class, a new secondary region may be defined and assigned a selected portion of the resources initially assigned to the primary region, provided that the number of secondary regions is below a selected threshold. Thus, when all the secondary regions have been defined, each new flow belonging to the traffic class is stored in the primary region for processing in flow aggregate form.
Also, in the event of detection of an end of flow associated with a secondary region associated with a traffic class, to the primary region associated with the traffic class may be reassigned all of the resources previously assigned to the secondary region.
A load status may advantageously be determined for each traffic class associated with a primary region by counting the number of secondary regions defined associated with the primary region concerned.

Other features and advantages of the invention will become apparent on reading the following detailed description and examining the appended drawings.

### BRIEF DESCRIPTION OF THE DRAWINGS

FIG. 1 shows diagrammatically one example of a communication network equipped with routers of the invention.

FIG. 2 shows diagrammatically one example of the division of internal resources of a router of the invention into four different traffic classes.

### DETAILED DESCRIPTION OF THE PREFERRED EMBODIMENT

The appended drawings constitute part of the description of the invention and may, if necessary, contribute to the definition of the invention.

One object of the invention is to provide for the adaptation of the quality of service (QoS) applied to data packets at routers of a communication network capable of processing aggregates of flows and flows of packets of data as a function of the load status of the routers. The network considered hereinafter by way of illustrative example is an Internet Protocol (IP) network.

In the present context, the expression “IP network” refers to a multidomain context consisting of a sum of interconnected IP domains.

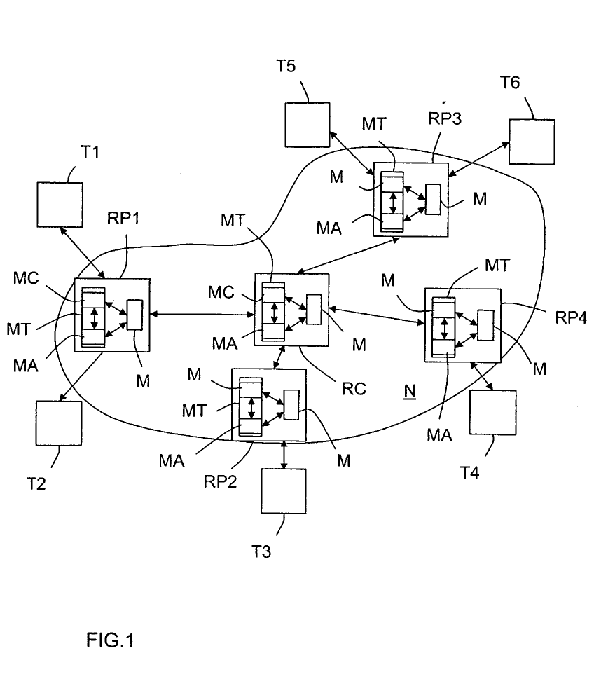

As shown in FIG. 1, an IP network N may be schematically regarded as a set of switching equipments (or nodes) RPi and RC interconnected to route data packets that they receive and a set of communication terminals Tj connected to certain switching equipments (or nodes) RPi, where applicable via one or more other access server terminals, to exchange packets of data.

The switching equipments (or nodes) are generally edge routers RPi (here i=1 to 4, but i can take any value greater than or equal to 1), and core routers. Here only one core router RC is shown, but there may be several of them. In an IP network, each domain has its own edge routers RPi and its own core routers.

Each communication terminal Tj is usually connected to one of the edge routers RPi, which serves as its Internet access protocol network node, and the edge routers RPi are generally interconnected by one or more core routers RC.

In the present context, the expression “communication terminal Tj” (here j=1 to 6, but j may take any value greater than or equal to 2), refers to any network equipment capable of exchanging data packets, for example a fixed or portable computer, a fixed or mobile telephone, a personal digital assistant (PDA), or a server.

To enable the above adaptation of quality of service (QoS) as a function of the load of the routers, the IP network N is equipped at least with core routers RC implementing the invention. However, it is preferable if its edge routers RPi also implement the invention, as shown in FIG. 1.

Since in the following description all the edge routers RPi and all the core routers RC implement the invention, they will no longer be differentiated.

A router RPi or RC of the invention comprises a processing module MT for determining an internal load status when it receives a flow of packets of data.

The load status of a router RPi or RC is representative of the percentage of at least some of its internal resources that have been assigned. As indicated in the introduction, the internal resources of a router are, for example, buffer memory areas M, generally of the first in first out (FIFO) type, or capacities of links (or connections) with other routers, or the computation (CPU) time for carrying out tasks (or processing).

When it receives a flow of packets of data associated with a class of traffic, the processing module MT of a router RPi or RC of the invention assigns that flow certain internal resources as a function of its traffic class and the load status that has just been determined, in order for it to be sent to another router of the network N.

As shown in FIG. 1, the processing module MT is preferably divided into at least two modules, namely an analysis module MA for determining the internal load status of the router and an assignment module MC for assigning internal resources. However, this division of the processing module MT into at least an analysis module MA and an assignment module MC is not obligatory.

As indicated in the introduction, the invention relates to any traffic class, and in particular flow by flow traffic (equivalent to IntServ), in which flows are processed independently of each other as a function of the flow identifier integrated into the packet header, flow aggregate(s) traffic (equivalent to DiffServ), in which flows are grouped into aggregates generally defining classes designated by a class identifier integrated into the header of the packet, and all intermediate traffic (equivalent to DPS), in which packets are processed as a function of selected information bits integrated into their header.

For example, in the case of IntServ traffic the flow identifier (“flow ID”) comprises 112 bits in the IPv4 version of the protocol and 304 bits in the IPv6 version of the protocol. In the case of DiffServ traffic the class identifier (“DS field”) comprises 6 bits, for example. In the case of intermediate traffic, the identifier comprises 6 to 112 bits (17 bits in the case of DPS traffic), for example.

It is important to note that in a router RPi or RC according to the invention the processing module MT, and preferably its assignment module MC, may define its own (traffic) classes dynamically, for example. Thus a class may be associated with a single flow or with a plurality of flows, or with a local flow aggregate, or an aggregate of local flow aggregates. Furthermore, classes may be combined if the load of the router, in terms of internal resources, is momentarily too high. Moreover, as each processing module MT defines its own classes, a flow may be associated with different classes in different routers on its path, and a flow may be associated with different classes at different times in the same router.

Accordingly, when a router RPi or RC receives a packet of a new flow, the assignment module MC of its processing module MT decides to process it in flow mode (equivalent to IntServ) or in aggregate mode (equivalent to DiffServ), for example, as a function of the load status determined by the associated analysis module MA.

If the router has sufficient internal resources, its assignment module MC then assigns a portion of them to the new flow for it to be processed in flow mode. The packets of this flow are then processed as a function of their flow identifier.

On the other hand, if the router does not have sufficient internal resources, its assignment module MC then associates the new flow with a class that it has previously defined so that it is processed with the other flows of that class in flow aggregate mode. The packets of that flow are then processed as a function of their class identifier.

As the load status of a router RPi or RC generally varies in time, each processing module MT is preferably adapted to redefine the assignment of internal resources dynamically.

For example, when a flow of packets or a flow aggregate has been entirely routed by a router RPi or RC, the internal resources that were associated with it may be reassigned to a flow of an aggregate or to a flow aggregate that has not yet been entirely routed (locally).

To reassign the internal resources, the processing module MT, and preferably its assignment module MC, preferably analyses the information that defines the quality of service (QoS) in the header of the packets or of the flow(s) affected by the reassignment. In this embodiment, only flows whose packets contain quality of service information may be the subject of local reassignment of internal resources.

The converse reassignment is equally possible. If a new flow or a new flow aggregate reaches a router RPi or RC whose load status prevents it from assigning sufficient internal resources (i.e. a new flow or a new flow aggregate constituting too great a load), its assignment module MC must either define a new class dedicated to the new flow or new flow aggregate and reassign to that new class a portion of the internal resources previously assigned to an old class, or define a new class on the basis of an old class by aggregating the new flow or the new flow aggregate with the flow or the flow aggregate associated with the old class and reassigning to that new class a portion of the internal resources previously assigned to the old class. Of course, this type of reassignment is possible only provided that the old and new flows comprise packets containing substantially identical class identifiers and/or flow identifiers.

When internal resources are released, the assignment module MC may equally de-aggregate flows that it has previously aggregated because of the earlier load status of its router and assign to the de-aggregated flows local resources corresponding to the quality of service information contained in their respective packets. Thus the packets of the de-aggregated flows change from an aggregate processing mode to a flow processing mode.

Compared to an IntServ processing mode, the processing mode of the invention allows an increase in load. If a router RPi or RC is saturated (and thus has no further internal resources available), each new flow received is processed in aggregate mode, which avoids increasing the quantity of status information that it has to store.

Compared to a DiffServ processing mode, the processing mode of the invention is able to process the greatest possible number of flows in flow mode, the remaining flows being processed in aggregate mode. At worst, a flow is processed in aggregate mode by all the routers of the network, so that all its packets receive DiffServ service. However, in the best situation all the packets of a flow may also be processed in flow mode by all the routers of the network, so that all its packets receive an IntServ service. In most cases, an intermediate situation occurs in which the service received by the packets of the flow over the whole of a path between the source and destination nodes is between the DiffServ and IntServ services.

Accordingly, thanks to the invention, the packets of a flow no longer receive minimum processing, as in the prior art, but the best possible processing given the load of each router RPi or RC. It is true that a flow initially processed in flow mode by a router may be momentarily processed in aggregate mode by the same router, which may limit the quality of service offered locally (at this router only). However, a flow initially processed in aggregate mode by a router may be momentarily processed in flow mode by the same router, which may improve the quality of service offered locally (at this router only).

The invention also provides a method of determining the load status of a router RPi or RC.

Using the processing module MT, and to be more precise its analysis module MA, all the internal resources of a router RPi or RC may be analyzed continuously. A different approach is equally possible, however, as explained hereinafter.

As the person skilled in the art is aware, when a router receives a packet of a flow it must first determine the output link (or connection) that it is going to use to send it to another router of the network, taking account of its destination address and the routing table that the router stores. Each output link is generally associated with a plurality of queues corresponding to different transmission services.

In the present context, the expression “queue” refers to a region of an FIFO memory M for processing packets as a function of their order of arrival and their flow identifier or class identifier contained in their header. In other words, a queue is usually dedicated to a flow or to a flow aggregate.

When the output link of a receive packet has been determined, the assignment module MC of the processing module MT of a router RPi or RC determines the queue in which it is going to place the packet, taking account of the flow identifier or the class identifier contained in its header.

The invention proposes to estimate the load status of a router RPi or RC as a function of the number of “active” queues within its buffer memories M. In the present context, the term “active” refers to a queue (or region of memory M) that has already been dedicated to a flow whose packets are being routed in a router RPi or RC.

To be more precise, the assignment module MC associates a memory region with each class that it defines and associates with each memory region internal resources of the router RPi or RC in which it is installed, adapted to the quality of service required by the packets of the flow(s) of the associated class.

For example, if a flow f is associated in a router with a class k, itself associated with a memory region q, each packet of the flow identified by a flow identifier f is stored temporarily in the queue of the memory region q to be transmitted when it is its turn.

When the flow f has been entirely routed by the router concerned, its assignment module MC eliminates class k and thereby releases the memory region q.

As a flow or a flow aggregate is associated with each active queue, each router RPi or RC must therefore store status information for each active queue.

Considering that a router RPi or RC initially has N queues in its memories M, taking account of its internal resources, each time that its assignment module MC creates a class k, it makes available to that class k a memory region q which may be divided into nₖ queues (or sub-regions).

The following equation then applies:

$$N = {\sum }_{k}^{} {n}_{k} .$$

The number nₖ of queues is not necessarily constant between classes. For example, this number may depend on the priority level of the class or on a management policy.

Each memory area q associated with a class k contains at least one queue dedicated to the processing of packets in flow aggregate mode, called the primary region. Consequently, a memory region q may comprise simultaneously at most nₖ−1 queues dedicated to the processing of packets in flow mode, called secondary regions.

When creating a new class k, only the aggregate primary region is defined in the memory region associated with that class. All the internal resources assigned to the class k are therefore initially assigned to the aggregate primary region. If the class k is associated with a plurality of flows, as soon as a new flow of the class k is received, the assignment module MC defines a secondary region so that the packets of the new flow are processed in flow mode. Each subsequent flow of class k is also associated with a new secondary region, provided that the maximum number nₖ−1 of secondary regions has not been reached. If a supplementary flow of class k reaches the router concerned, the assignment module MC associates it with the aggregate primary region and all its packets will be processed in aggregate mode.

Each time that a flow secondary region is created, the status information of the associated flow is stored in the memory of the router RPi or RC dedicated to this purpose.

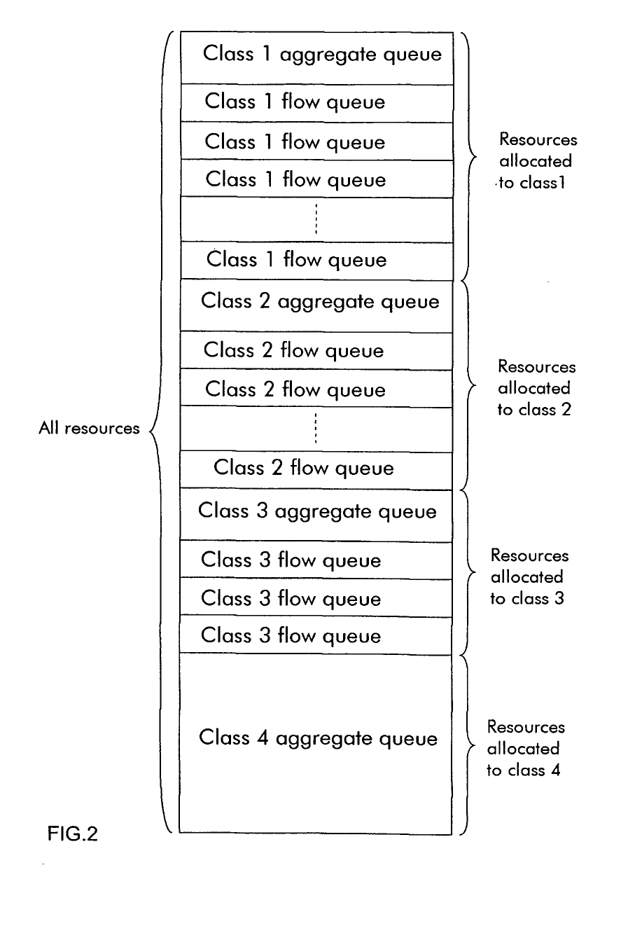

FIG. 2 represents one example of the distribution between four different traffic classes of the internal resources of a router RPi or RC according to the invention.

To be more precise, in this example, firstly, the resources assigned to class 1 are divided between an aggregate primary region (“Class 1 aggregate queue”) and n₁−1 flow secondary regions (“Class 1 flow queue”), secondly, the resources assigned to class 2 are divided between an aggregate primary region (“Class 2 aggregate queue”) and n₂−1 flow secondary regions (“Class 2 flow queue”), thirdly, the resources assigned to class 3 are divided between an aggregate primary region (“Class 3 aggregate queue”) and n₃−1=3 flow secondary regions (“Class 1 flow queue”), and, fourthly, the resources assigned to class 4 are all assigned to the aggregate primary region (“Class 4 aggregate queue”), either because the n₄−1 flows previously associated with the flow secondary regions have all been entirely routed or because class 4 has just been defined.

When a flow f of a class k has been entirely routed by the router concerned, its assignment module MC “eliminates” the secondary region that was associated with it and reassigns its internal resources to the aggregation primary region associated with class k.

The same applies when the load on the router is too high and it is confronted with a rush of flows or flow aggregates. In this situation, the assignment module MC of its processing module MT may decide, as previously indicated, to associate one or more flows of a class, previously associated with secondary regions, to the primary region of that class. This frees up the internal resources that were assigned to the secondary regions for reassignment to a new class associated with the new flows.

Each time that a flow secondary region is eliminated, the status information of the associated flow is deleted from the memory of the router RPi or RC dedicated to this purpose.

As the active queues in a router are each associated with certain internal resources of the router, the number of active queues is therefore representative of the load status of a router RPi or RC.

It is therefore sufficient for the analysis module MA of the processing module MT to count the number of secondary regions used for each class to determine the total number of secondary regions used and deduce therefrom the load status of its router RPi or RC.

It is important to note that the classes may be defined within a router statistically, for example by the operator of the network (or domain) to which it belongs, or dynamically. In the static situation, certain classes are dedicated to the processing of packets in aggregate mode, and other classes are dedicated to the processing of packets in aggregate mode and in flow mode. In the dynamic situation, the router adapts or creates its classes as a function of requirements.

The routers RPi and RC of the invention, and in particular their processing modules MT, assignment modules MC and analysis modules MA, and where applicable their FIFO memories M, may be implemented in the form of electronic circuits, software (or data processing) modules, or a combination of circuits and software.

The invention also provides a method of processing packets of data for routing within a communication network N, for example an IP network, comprising loaded routers RPi and/or RC which, when they receive a flow of packets of data associated with a class of traffic, assign that flow internal resources as a function of its traffic class, in order for it to be sent to at least one other router of the network.

This method may be implemented with the aid of the routers RPi and RC described hereinabove. The main and optional functions and subfunctions of the steps of the method being substantially identical to those of the means constituting the routers RPi and RC, only the steps implementing the main functions of the method of the invention are summarized hereinafter.

When a flow of packets is received at a router RPi or RC, this method determines an internal load status of the router and then assigns certain of its internal resources to the received flow as a function of its traffic class and the load status that has been determined.

The invention is not limited to the embodiments of a router and a processing method described above by way of example only, and encompasses all variants within the scope of the following claims that the person skilled in the art might envisage.

1. A router for a communication network comprising processing means adapted, on receiving a flow of packets of data associated with a class of traffic, to assign the flow internal resources of said router as a function of its traffic class in order for it to be transmitted to at least one other router of said network, which processing means are adapted to determine an internal load status of said router and to assign internal resources to a received flow as a function of its traffic class and the load status that has been determined, said traffic class being selected from a group comprising “flow by flow” traffic and “flow aggregate” traffic.

2. The router claimed in claim 1 wherein said processing means are adapted to aggregate received flows associated with the same traffic class to define local aggregates and to assign said local aggregates internal resources assigned to that traffic class, at least temporarily.

3. The router claimed in claim 2 wherein said processing means are adapted to aggregate locally flow aggregates associated with the same traffic class, to define local aggregate aggregates and to assign to the local aggregate aggregates internal resources assigned to that traffic class, at least temporarily.

4. The router claimed in claim 2 wherein said processing means are adapted, in the event of releasing of internal resources assigned to a traffic class, to de-aggregate flows or flow aggregates previously aggregated locally, and then to assign said flows or flow aggregates at least certain of the released internal resources.

5. The router claimed in claim 1 wherein said processing means are adapted, when said packets of a flow comprise quality of service information and said load status allows it, to de-aggregate flows previously aggregated locally and assign them local resources corresponding to the quality of service information contained in their respective packets.

6. The router claimed in claim 1, further comprising memories adapted to store received packets temporarily in queues and to transmit them as a function of an order of arrival and of belonging to a traffic class, and wherein said processing means are adapted to define within each queue associated with a traffic class a primary storage region dedicated to flow aggregation and at least one secondary storage region dedicated to a flow of this traffic class.

7. The router claimed in claim 6 wherein said processing means are adapted to assign a selected set of internal resources to a primary region associated with a traffic class and then, on receipt of each new flow belonging to said traffic class, to define a new secondary region and assign that secondary region a selected portion of the resources initially assigned to said primary region, provided that the number of secondary regions is below a selected threshold, and when all said secondary regions have been defined, each new flow belonging to said traffic class is stored in said primary region for processing in flow aggregate form.

8. The router claimed in claim 7 wherein said processing means are adapted, in the event of detection of an end of flow associated with a secondary region associated with a traffic class, to reassign to the primary region associated with said traffic class all of the resources previously assigned to said secondary region.

9. The router claimed in claim 6 wherein said processing means are adapted to determine a load status for each traffic class associated with a primary region by counting the number of secondary regions defined associated with said primary region.

10. A method of processing packets of data for routing in a communication network comprising routers adapted, on receiving a flow of packets of data associated with a class of traffic, to assign said flow internal resources as a function of its traffic class in order for it to be transmitted to at least one other router of said network, which method comprises in, on receiving a flow of packets at a router, determining an internal load status of said router and then assigning internal resources to the received flow as a function of its traffic class and of the load status that has been determined, said traffic class being selected from the group comprising “flow by flow” traffic and “flow aggregate” traffic.

11. The method claimed in claim 10 wherein, when said load status is representative of a high load, received flows associated with the same traffic class are aggregated to define local aggregates, and then said local aggregates are assigned internal resources of the router concerned, assigned to said traffic class, at least temporarily.

12. The method claimed in claim 11 wherein, when said load status is representative of a very high load, flow aggregates associated with the same traffic class are aggregated locally to define local aggregate aggregates, and then said local aggregate aggregates are assigned internal resources of the router concerned, allocated to said traffic class, at least temporarily.

13. The method claimed in claim 11 wherein, in the event of releasing of internal resources assigned to a traffic class at a router, flows or flow aggregates previously aggregated locally are de-aggregated and then said flows or flow aggregates are assigned at least certain of the released internal resources.

14. The method claimed in claim 10 wherein, when the packets of a flow contain quality of service information and the load status of a router allows it, flows previously aggregated locally are de-aggregated and assigned local resources corresponding to the quality of service information contained in their respective packets.

15. Use of the router as claimed in claim 1 in an Internet Protocol network.

16. Use of the method as claimed in claim 10 in an Internet Protocol network.
